(19) United States
(12) Patent Application Publication
(10) Pub. No.: US 2008/0102757 A1
(43) Pub. Date: May 1, 2008

(54) Apparatus and method for monitoring state of RF front end in wireless communication system

(75) Inventor: Byung-Wook Kim, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 11/977,841

(22) Filed: Oct. 26, 2007

(30) Foreign Application Priority Data
Oct. 27, 2006 (KR) 2006-0105308

(51) Int. Cl. H04B 17/00

(52) U.S. Cl. 455/67.11

(57) ABSTRACT

Provided is an apparatus and method for monitoring the state of an RF front end in a wireless communication system. The apparatus includes a band-pass filter, a thermal noise measurer, and a state detector. The band-pass filter passes only signals that lie within a communication band among signals received through an antenna. The thermal noise measurer measures the strength of a thermal noise signal in a first band passing signals in the band-pass filter and the strength of a thermal noise signal in a second band not passing signals in the band-pass filter. The state detector detects the state of the RF front end using the detected strengths of the thermal noise signals in the first and second bands. Therefore, the state of the RF front end of the transceiver can be monitored without additional hardware implementation.

### CROSS-REFERENCE TO RELATED APPLICATION(S) AND CLAIM OF PRIORITY

The present application claims priority under 35 U.S.C. § 119 to an application filed in the Korean Intellectual Property Office on Oct. 27, 2006 and allocated Serial No. 2006-0105308, the contents of which are incorporated herein by reference.

### TECHNICAL FIELD OF THE INVENTION

The present invention relates generally to a wireless communication system, and in particular, to an apparatus and method for monitoring the state of a radio-frequency (RF) front end in a wireless communication system.

### BACKGROUND OF THE INVENTION

A high-speed wireless data communication service is being expanded to provide a multimedia service based on the development of mobile communication technologies. Thus, a multi-antenna system is widely used for high-speed wireless data communication.

If a wireless communication system uses a multi-antenna system, its wireless link environment may become worse or its total data transmission rate may be reduced due to the malfunction or the performance degradation of a transceiver for each antenna. Thus, the wireless communication system requires a high-performance wireless transceiver for the use of the multi-antenna system.

In a wireless communication system, the malfunction of the wireless transceiver results from the malfunction of an RF front end or the failure of a low-noise amplifier (LNA). For example, the failure of the LNA results from the input of an excessively large RF signal or the supply of an unstable power voltage. For example, the malfunction of the RF front end results from a mismatch between functional blocks of the RF front end due to unstable coupling or physical damage. The mismatch denotes a state of mismatch between the input/output characteristic impedances of the functional blocks.

Such an impedance mismatch causes an echo component of an RF signal transmitted between the functional blocks, leading to the phase distortion or the strength reduction of the RF signal.

Therefore, the functional blocks must be impedance-matched for their normal operations.

In order to prevent the malfunction due to the impedance mismatch, the wireless communication system monitors the state of the RF front end as illustrated in FIG. 1.

FIG. 1 is a block diagram of a transceiver in a conventional wireless communication system.

Referring to FIG. 1, the transceiver includes an antenna 101, a duplexer 103, a transmitter, and a receiver.

The duplexer 103 is used to allow the antenna 101 to be shared by the transmitter and the receiver.

The transmitter includes an echo detector 105, a power amplifier (PA) 107, an up-converter 109, and a modem 117.

The modem 117 encodes a transmit (TX) baseband signal at a predetermined coding rate, and modulates the resulting signal in a predetermined modulation scheme.

The up-converter 109 up-converts a baseband signal received from the modem 117 into an RF signal.

The PA 107 amplifies the power of an RF signal received from the up-converter 109, to the extent that is suitable for transmission over a radio channel through the antenna 101.

The echo detector 105 protects the PA 107 by monitoring an echo signal resulting from a mismatch between the antenna 101 and the duplexer 103. For example, if the strength of the echo signal is larger than a critical value, the echo detector 105 stops the operation of the PA 107.

The receiver includes a receiver protector 111, an LNA 113, a down-converter 115, and the modem 117.

The receiver protector 111 prevents the echo signal or the transmit (TX) signal of the transmitter from flowing into the receiver.

The LNA 113 low-noise amplifies an RF signal received through the antenna 101. The down-converter 115 down-converts an RF signal received from the LNA 113 into a baseband signal.

The modem 117 demodulates a baseband signal received from the down-converter 115 in accordance with a predetermined modulation scheme, and decodes the resulting signal at a predetermined coding rate.

As described above, using the echo detector 105 of the transmitter, the conventional wireless communication system determines that a malfunction has occurred in an RF front end if the strength of the echo signal is larger than the critical value. Thus, the conventional wireless communication system cannot monitor a malfunction of the RF front end that occurs when the strength of the echo signal is smaller than the critical value.

Moreover, if the transmitter and the receiver use separate antennas, the receiver cannot monitor the malfunction of the RF front end.

### SUMMARY OF THE INVENTION

To address the above-discussed deficiencies of the prior art, it is a primary object of the present invention to substantially solve at least the above problems and/or disadvantages and to provide at least the advantages below. Accordingly, an object of the present invention is to provide an apparatus and method for monitoring the state of an RF front end in a wireless communication system.

Another object of the present invention is to provide an apparatus and method for monitoring the state of an RF front end in a wireless communication system by using the matching characteristics of RF blocks.

Still another object of the present invention is to provide an apparatus and method for monitoring the state of an RF front end in a wireless communication system by using a change in the power density of a thermal noise depending on the matching characteristics of RF blocks.

According to one aspect of the present invention, an apparatus for monitoring the state of an RF front end in a wireless communication system includes: a band-pass filter for passing only signals that lie within a communication band among signals received through an antenna; a thermal noise measurer for measuring the strength of a thermal noise signal in a first band passing signals in the band-pass filter and the strength of a thermal noise signal in a second band not passing signals in the band-pass filter; and a state detector for detecting the state of the RF front end using the detected strengths of the thermal noise signals in the first and second bands.

According to another aspect of the present invention, a method for monitoring the state of an RF front end in a wireless communication system includes the steps of: measuring the strength of a thermal noise signal in a first band passing signals in a band-pass filter and the strength of a thermal noise signal in a second band not passing signals in the band-pass filter; and detecting the state of the RF front end using the detected strengths of the thermal noise signals in the first and second bands.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a transceiver in a conventional wireless communication system;

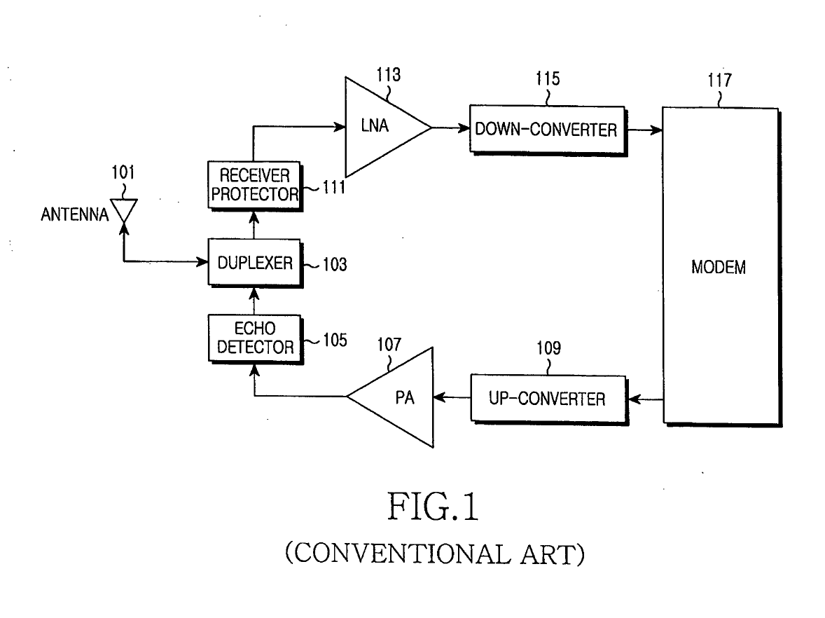

FIG. 2 is a block diagram of a transceiver for monitoring the state of an RF front end in a wireless communication system according to an embodiment of the present invention;

FIG. 3 is a block diagram of a transceiver for monitoring the state of an RF front end in a wireless communication system according to another embodiment of the present invention;

FIG. 4 is a block diagram of a state analyzer according to the present invention;

FIG. 5 is a flowchart illustrating a procedure for monitoring the state of an RF front end according to an embodiment of the present invention;

FIGS. 6A to 6C are diagrams illustrating the band-dependent matching characteristics of a BPF according to an embodiment of the present invention; and

FIGS. 7A to 7C are diagrams illustrating the band-dependent mismatching characteristics of a BPF according to an embodiment of the present invention.

### DETAILED DESCRIPTION OF THE INVENTION

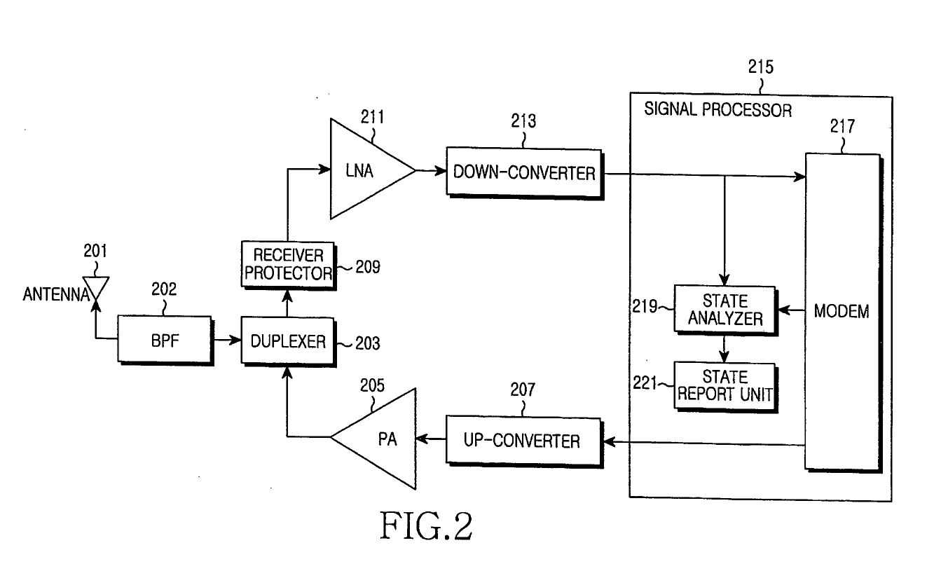

FIGS. 2 through 7C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless system.

The present invention is intended to provide a technique for monitoring the state of an RF front end in a wireless communication system by using a change in the gain of a receiver depending on the matching characteristics of RF blocks.

The wireless communication system malfunctions if there is an input/output impedance mismatch between RF blocks. The impedance mismatch denotes a state of mismatch between the input/output characteristic impedances of the RF blocks. The impedance mismatch reduces the gain of an active RF block and increases the insertion loss of a passive RF block.

Hereinafter, a description is given of a technique for monitoring the state of the RF front end in the wireless communication system by measuring a change in the gain of the receiver depending on the matching characteristics of the RF blocks.

FIG. 2 is a block diagram of a transceiver for monitoring the state of an RF front end in a wireless communication system according to an embodiment of the present invention.

Referring to FIG. 2, the transceiver includes an antenna 201, a Band-Pass Filter (BPF) 202, a duplexer 203, a transmitter, and a receiver.

The BPF 202 passes only signals that lie within a band used by the transceiver, among signals transmitted/received through the antenna 201. Thus, the input/output terminals of the BPF 202 are matched in a pass band, while they are mismatched in a band except the pass band (hereinafter referred to as a stop band). In this case, when the BPF 202 is connected to an active RF block such as an LNA 211, the active RF block has a gain difference between the pass band and the stop band. Herein, it is assumed that a first terminal of the BPF 202 connected to the active RF block matches with a second terminal of the BPF 202 connected for example to the antenna 201.

However, if there is a mismatch between the first and second terminals of the BPF 202, the transfer property of the pass band of the BPF 202 is reduced and the active RF block has no gain difference between the pass band and the stop band.

The duplexer 203 is used to allow the antenna 201 to be shared by the transmitter and the receiver.

The transmitter includes a power amplifier (PA) 205, an up-converter 207, and a signal processor 215.

The signal processor 215 includes a modem 217 that encodes a TX baseband signal at a predetermined coding rate and modulates the resulting signal in a predetermined modulation scheme. Although not illustrated in FIG. 2, the transmitter further includes a digital-to-analog (D/A) converter between the up-converter 207 and the signal processor 215, which converts a digital signal received from the signal processor 215 into an analog signal.

The up-converter 207 up-converts a baseband signal received from the modem 217 into an RF signal.

The PA 205 amplifies the power of an RF signal received from the up-converter 207, to the extent that is suitable for transmission over a radio channel through the antenna 201. Although not illustrated in FIG. 2, the PA 205 includes an echo detector in order to reduce a loss due to an echo signal resulting from a mismatch between the antenna 201 and the duplexer 203. The echo detector protects the PA 205 by monitoring an echo signal resulting from a mismatch between the antenna 201 and the duplexer 203. For example, if the strength of the echo signal is larger than a critical value, the echo detector stops the operation of the PA 205.

The receiver includes a receiver protector 209, a low-noise amplifier (LNA) 211, a down-converter 213, and the signal processor 215.

The receiver protector 209 prevents the echo signal or the TX signal of the transmitter from flowing into the receiver.

The LNA 211 low-noise amplifies an RF signal received through the antenna 201. If the RF front end operates normally, the LNA 211 has a gain difference between the pass band and the stop band of the BPF 202. However, if the RF front end malfunctions, the LNA 211 has no gain difference between the pass band and the stop band.

The down-converter 213 down-converts an RF signal received from the LNA 211 into a baseband signal.

The signal processor 215 includes the modem 217, a state analyzer 219, and a state report unit 221. Although not illustrated in FIG. 2, the receiver further includes an analog-to-digital (A/D) converter between the down-converter 213 and the signal processor 215 for digital signal processing of the signal processor 215.

The modem 217 demodulates a baseband signal received from the down-converter 213 in accordance with a predetermined modulation scheme, and decodes the resulting signal at a predetermined coding rate. Also, the modem 217 calculates the strengths of a thermal noise of a received (RX) signal in the pass band and the stop band and provides the calculated thermal noise strengths to the state analyzer 219.

Using the thermal noise strength of the received (RX) signal, the state analyzer 219 calculates the power densities of the thermal noise in the pass band and the stop band. The state analyzer 219 monitors the state of the RF front end using the calculated power density of the thermal noise. In this embodiment, while there is an RX signal, the state analyzer 219 calculates the power density of the thermal noise by using the thermal noise strength received from the modem 217. Also, while there is no RX signal, the state analyzer 219 calculates the power density of the thermal noise by measuring the thermal noise strength by itself, in order to reduce the load on the modem 217. In an alternative embodiment, the sate analyzer 219 may measure the thermal noise strength by itself or the modem 217 may measure the thermal noise strength, regardless of the existence of an RX signal.

If a malfunction of the RF front end is monitored by the state analyzer 219, the state report unit 221 reports the malfunction of the RF front end to an upper layer. For example, in the case of a code division multiple access (CDMA) communication system, the state report unit 221 reports the malfunction of the RF front end to a base station controller (BSC). Also, in case of the malfunction of the RF front end, the wireless communication system stops the operation of the PA 205 or operates the receiver protector 209.

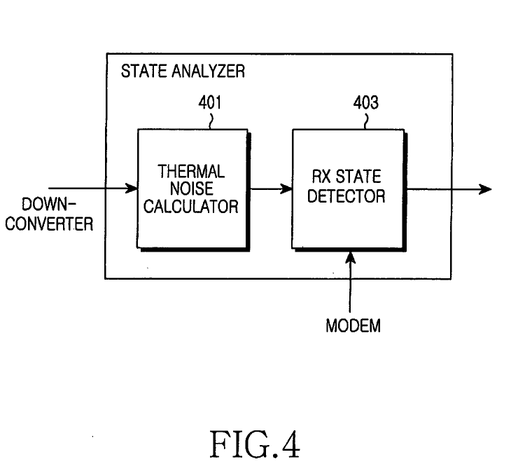

FIG. 4 is a block diagram of the state analyzer 219 according to an embodiment of the present invention.

Referring to FIG. 4, the state analyzer 219 includes a thermal noise calculator 401 and an RX state detector 403.

The thermal noise calculator 401 calculates the strength of a thermal noise signal that is down-converted from the pass band and the stop band into a baseband while there is no RX signal in the receiver. In order to reduce the load on the modem 217, the thermal noise strength is calculated by the thermal noise calculator 401 while there is no RX signal. While there is an RX signal, the thermal noise strength is calculated by the modem 217.

If there is the RX signal, the RX state detector 403 calculates the power density of a thermal noise signal as Equation (1) using the pass-band/stop-band thermal noise signal received from the modem 217. If there is no RX signal, the RX state detector 403 calculates the power density of a thermal noise signal as Equation (1) using the pass-band/stop-band thermal noise signal received from the thermal noise calculator 401.

No_pass=N_pass÷BW_pass

No_stop=(N_stop_{—}1+N_stop_{—}2)÷(BW_stop_{—}1+BW_stop_{—}2) (1)

where No_pass denotes the power density of a thermal noise signal in the pass band, No_stop denotes the power density of a thermal noise signal in the stop band, N_pass denotes the strength of a thermal noise signal in the pass band, BW_pass denotes the bandwidth of the pass band, N_stop_i denotes the strength of a thermal noise signal in the i^{th} stop band, and BW_stop_i denotes the bandwidth of the i^{th} stop band.

Thereafter, the RX state detector 403 detects the state of the RF front end by comparing the power density of a thermal noise signal in the pass band with the power density of a thermal noise signal in the stop band. For example, if a power density difference between the pass-band thermal noise signal and the stop-band thermal noise signal is equal to or greater than a reference value, the RX state detector 403 determines that the RF front end operates normally. If the power density difference between the pass-band thermal noise signal and the stop-band thermal noise signal is smaller than the reference value, the RX state detector 403 determines that the RF front end operates abnormally.

As described above, if the terminals of the antenna 201 exhibit normal matching characteristics without unstable coupling or physical damage, the input/output terminals of the BPF 202 are matched in the pass band and mismatched in the stop band.

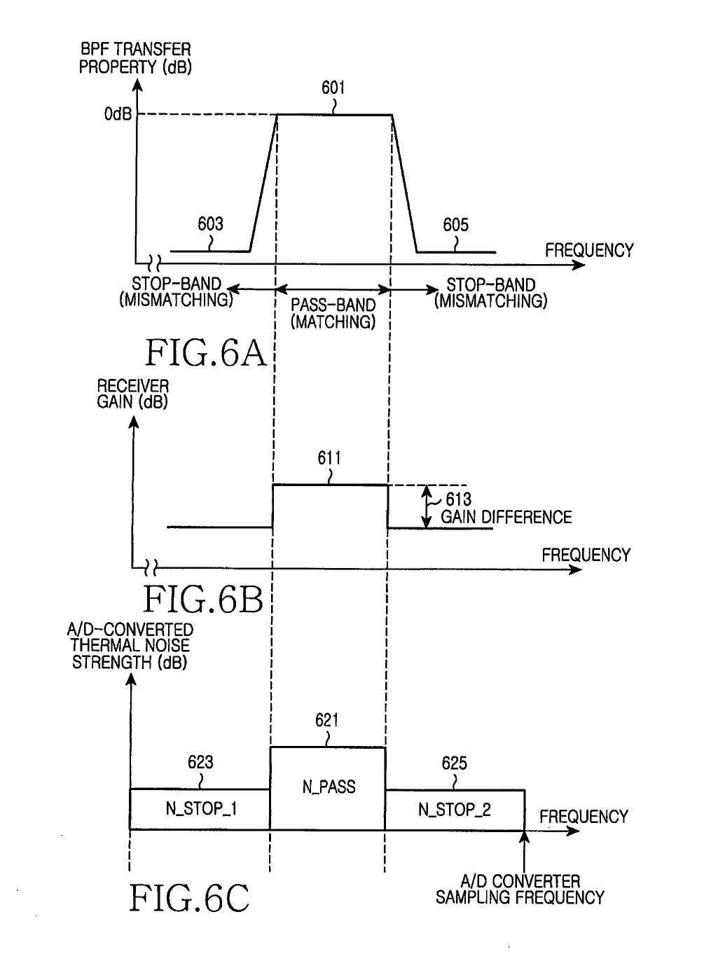

FIGS. 6A to 6C are diagrams illustrating the matching characteristics of the BPF 202 according to an embodiment of the present invention.

As illustrated in FIG. 6A, if the terminals of the antenna 201 exhibit normal matching characteristics, the BPF 202 has matching characteristics 601 in the pass band and mismatching characteristics 603 and 605 in the stop band.

If the BPF 202 has matching characteristics as illustrated in FIG. 6A, the receiver has a gain difference between the pass band and the stop band as illustrated in FIG. 6B. That is, the gain of the receiver is higher in the pass band than in the stop band.

Because the receiver has a gain difference between the pass band and the stop band, the thermal noise signal down-converted into a baseband signal has a gain difference between the pass band and the stop band in the receiver. Thus, the receiver receives thermal noise signals with different strengths in the pass band and the stop band as illustrated in FIG. 6C.

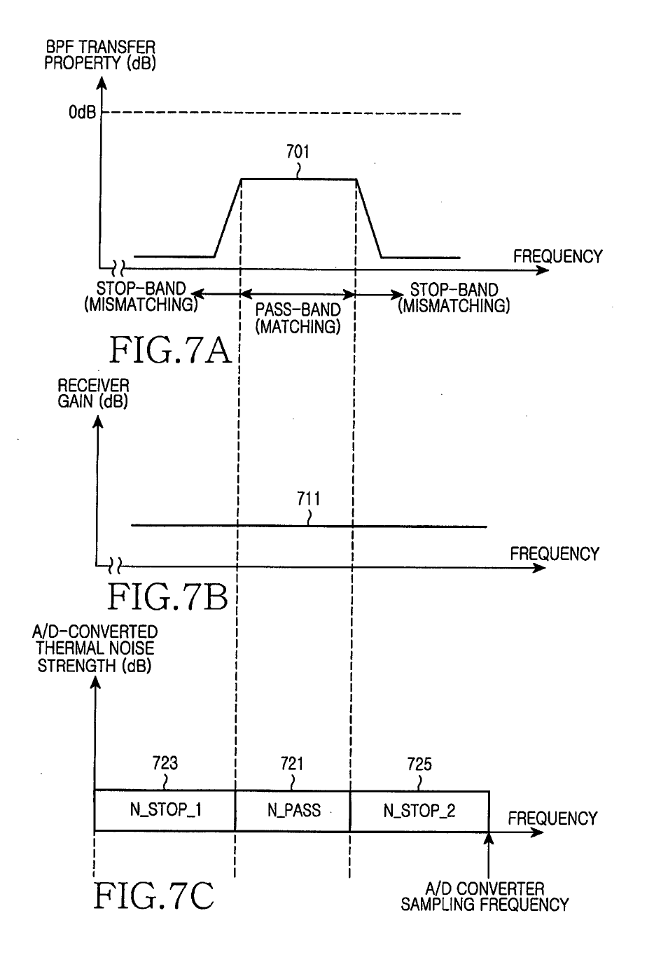

However, if the terminals of the antenna 201 exhibit mismatching characteristics due to unstable coupling or physical damage, the transfer property of the pass band of the BPF 202 is reduced as illustrated in FIGS. 7A to 7C.

FIGS. 7A to 7C are diagrams illustrating the mismatching characteristics of the BPF 202 according to an embodiment of the present invention.

As illustrated in FIG. 7A, if the terminals of the antenna 201 exhibit mismatching characteristics, the pass band of the BPF 202 has the transfer property 701 smaller than the transfer property 601 (if the terminals of the antenna 201 exhibit matching characteristics as illustrated in FIGS. 6A to 6C). In this case, as illustrated in FIG. 7B, the pass-band gain 711 is reduced and the receiver has no gain difference between the pass band and the stop band.

Because the receiver has no gain difference between the pass band and the stop band, the thermal noise signal down-converted into a baseband signal has no gain difference between the pass band and the stop band in the receiver. Thus, the receiver receives thermal noise signals with the same strength in the pass band and the stop band as illustrated in FIG. 7C.

Therefore, the state analyzer 219 can monitor the state of the RF front end by comparing the power density of the pass band with the power density of the stop band depending on the thermal noise strengths.

In the above embodiment, because the pass band and the stop band are different in size, the state analyzer 219 can monitor the state of the RF front end by comparing the power density of the pass band with the power density of the stop band depending on the thermal noise strengths. If the pass band and the stop band are identical in size, the state analyzer 219 can monitor the state of the RF front end by comparing the thermal noise strengths.

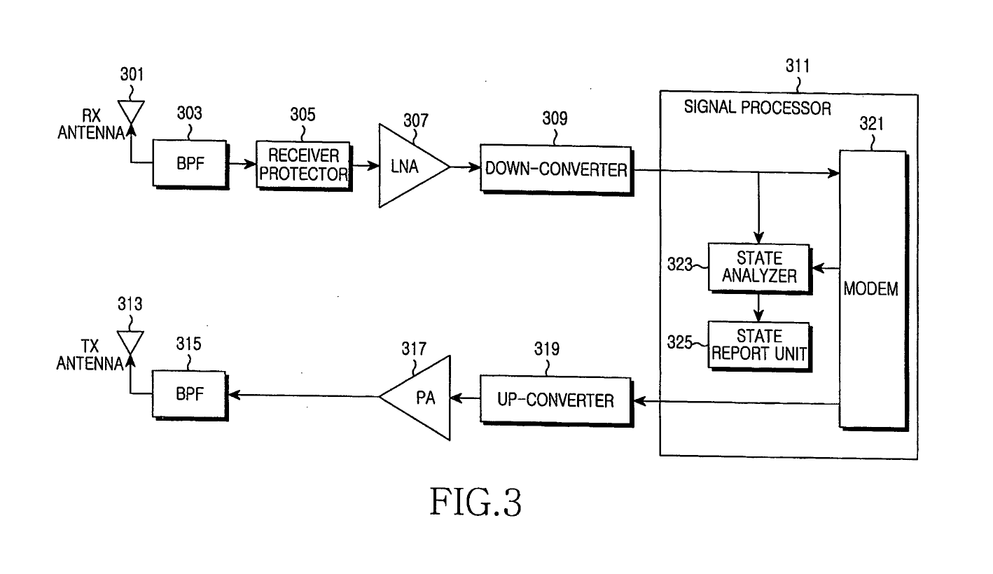

FIG. 3 is a block diagram of a transceiver for monitoring the state of an RF front end in a wireless communication system according to another embodiment of the present invention.

The transmitter and the receiver of in the embodiment of FIG. 2 share a single antenna, whereas a transmitter and a receiver in the embodiment of FIG. 3 use separate antennas. The wireless communication system of FIG. 3 is substantially identical in configuration to the wireless communication system of FIG. 2 and thus its description will be omitted for conciseness.

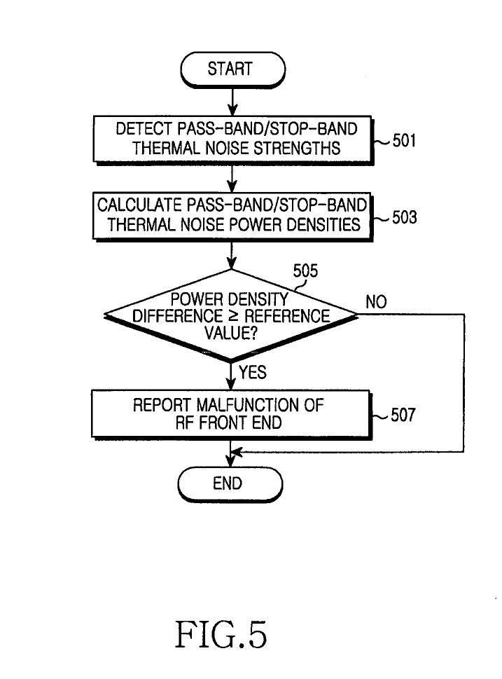

FIG. 5 is a flowchart illustrating a procedure for monitoring the state of the RF front end according to an embodiment of the present invention.

Referring to FIG. 5, in step 501, the state analyzer 219 detects the strengths of the thermal noise signals in the pass band and the stop band. For example, if there is no RX signal, the state analyzer 219 calculates the thermal noise strengths in the pass band and the stop band using the thermal noise calculator 401. On the other hand, if there is an RX signal, the state analyzer 219 detects the pass-band/stop-band thermal noise strengths measured by the modem 217.

In step 503, the state analyzer 219 calculates the power densities of the thermal noise signals in the pass band and the stop band using the detected pass-band/stop-band thermal noise strengths.

In step 505, the state analyzer 219 compares a power density difference between the pass-band/stop-band thermal noise signals with a reference value to determine whether the RF front end operates normally.

If the power density difference is equal to or greater than the reference value, the state analyzer 219 proceeds to step 507, determining that the RF front end malfunctions. In step 507, using the state report unit 221, the state analyzer 219 reports the malfunction of the RF front end.

On the other hand, if the power density difference is smaller than the reference value, the state analyzer 219 ends the procedure, determining that the RF front end operates normally.

In the above embodiments, the state of the RF front end is monitored using the matching characteristics of the BPF. In another embodiment, the state of the RF front end may be monitored using the matching characteristics of the BPF.

In accordance with the present invention as described above, the state of the RF front end is monitored using the gain change of the receiver depending on the matching characteristics of the RF blocks in the wireless communication system. Therefore, the state of the RF front end of the transceiver can be monitored without additional hardware implementation. Thus, the stable operation of the wireless communication system can be provided and the performance degradation of the receiver can be prevented.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for monitoring the state of a radio frequency (RF) front end in a wireless communication system, the apparatus comprising:
a band-pass filter for passing only signals that lie within a communication band among signals received through an antenna;
a thermal noise measurer for measuring the strength of a thermal noise signal in a first band passing signals in the band-pass filter and the strength of a thermal noise signal in a second band not passing signals in the band-pass filter; and
a state detector for detecting the state of the RF front end using the detected strengths of the thermal noise signals in the first and second bands.

2. The apparatus of claim 1, further comprising:
a low-noise amplifier for low-noise amplifying the power of an RF signal received from the band-pass filter;
a down-converter for down-converting the RF signal received from the low-noise amplifier into a baseband analog signal; and
an analog-to-digital converter for converting the baseband analog signal received from the down-converter into a baseband digital signal and providing the baseband digital signal to the thermal noise measurer,
wherein the thermal noise measurer measures the strengths of thermal noise signals using the baseband digital signal.

3. The apparatus of claim 1, wherein when there is no received (RX) signal, the thermal noise measurer measures the strength of a thermal noise signal; and when there is an RX signal, the thermal noise measurer measures the strength of a thermal noise signal included in the RX signal.

4. The apparatus of claim 1, wherein the thermal noise measurer comprises:
a thermal noise calculator for measuring the strength of a thermal noise signal when there is no received (RX) signal; and
a modem for measuring, if there is an RX signal, the strength of a thermal noise signal included in the RX signal.

5. The apparatus of claim 4, wherein the modem measures the strength of the thermal noise signal included in the RX signal, demodulates the RX signal in accordance with a predetermined modulation scheme, and decodes the resulting signal at a predetermined coding rate.

6. The apparatus of claim 1, wherein the state detector calculates the power densities of the thermal noise signals in the first and second bands using the strengths of the thermal noise signals, and detects the state of the RF front end by comparing the power densities of the thermal noise signals in the first and second bands.

7. The apparatus of claim 6, wherein if a power density difference between the thermal noise signals in the first and second bands is equal to or greater than a reference value, the state detector determines that the RF front end operates normally; and if the power density difference is smaller than the reference value, the state detector determines that the RF front end malfunctions.

8. The apparatus of claim 1, wherein if the first and second bands are identical in size and if a strength difference between the thermal noise signals in the first and second bands is equal to or greater than a reference value, the state detector determines that the RF front end operates normally; and if the strength difference is smaller than the reference value, the state detector determines that the RF front end malfunctions.

9. The apparatus of claim 1, further comprising a state report unit for reporting, if the RF front end malfunctions, the malfunction of the RF front end to an upper layer.

10. A method for monitoring the state of a radio frequency (RF) front end in a wireless communication system, the method comprising:
measuring the strength of a thermal noise signal in a first band passing signals in a band-pass filter and the strength of a thermal noise signal in a second band not passing signals in the band-pass filter; and
detecting the state of the RF front end using the detected strengths of the thermal noise signals in the first and second bands.

11. The method of claim 10, wherein the step of measuring the strengths of the thermal noise signals comprises:
low-noise amplifying the power of an RF signal received from the band-pass filter;
down-converting the amplified RF signal into a baseband analog signal; and
converting the baseband analog signal into a baseband digital signal and measuring the strengths of the thermal noise signals using the baseband digital signal.

12. The method of claim 10, wherein when there is no received (RX) signal, the strength of a thermal noise signal is measured;
and when there is an RX signal, the strength of a thermal noise signal included in the RX signal is measured.

13. The method of claim 10, wherein the step of detecting the state of the RF front end comprises:
calculating the power densities of the thermal noise signals in the first and second bands using the strengths of the thermal noise signal; and
detecting the state of the RF front end by comparing the power densities of the thermal noise signals in the first and second bands.

14. The method of claim 13, wherein the step of detecting the state of the RF front end comprises:
determining that the RF front end operates normally, if a power density difference between the thermal noise signals in the first and second bands is equal to or greater than a reference value; and
determining that the RF front end malfunctions, if the power density difference is smaller than the reference value.

15. The method of claim 10, wherein the step of detecting the state of the RF front end comprises:
comparing the sizes of the first and second bands;
determining that the RF front end operates normally, if the first and second bands are identical in size and if a strength difference between the thermal noise signals in the first and second bands is equal to or greater than a reference value; and
determining that the RF front end malfunctions, if the strength difference is smaller than the reference value.

16. The method of claim 10, further comprising reporting, if the RF front end malfunctions, the malfunction of the RF front end to an upper layer.
